(19) United States
(12) Patent Application Publication
(10) Pub. No.: US 2008/0195593 A1
(43) Pub. Date: Aug. 14, 2008

(54) Online Media Content Transfer

(76) Inventors: Pasi Harju, Suinula (FI); Tatu Helander, Tampere (FI)

Correspondence Address: PERMAN & GREEN, 425 POST ROAD, FAIRFIELD, CT, 06824, US

(21) Appl. No.: 11/576,091

(22) PCT Filed: Sep. 28, 2005
(86) PCT No.: PCT/FI05/50333

§ 371 Date: Oct. 26, 2007

(30) Foreign Application Priority Data
Sep. 28, 2004 (FI) 20045357

(51) Int. Cl. G06F 7/06; G06F 17/30

(52) U.S. Cl. 707/5; 707/E17.102

(57) ABSTRACT

The invention relates to a system and a method and a computer program product for transferring media content via network. The system includes a content provider (210) and at least one client device (280) and a network connection (290) configured between them, and also a database (220) for storing the media content. The content provider (210) is configured to receive a request (from the client device (280), which request identifies the content the client desires. The request is a constant request and the content provider (210) is configured to select the content being transferred dynamically to the client (280).

### FIELD OF THE INVENTION

The current invention relates generally to a method and a system and a computer program product for providing media content via network. A request is transferred via network to a content provider, whereby the content is transferred from the content provider to the client.

### BACKGROUND OF THE INVENTION

Music in public houses, bars and nightclubs is an enormous factor for livening up the environment. Service providers typically offer music by means of live bands, but also by records. Typically, e.g. during off-peaks, service provider constantly plays CDs or radio. In the foremost case the a servant is usually in charge for changing the music. Typically one disc is played from a beginning to an end after which the next disc is started. In the latter case the radio rarely provides continuous music without speak and the music is typically formed into playlists, which can not be affected. In addition the copyright supervision can be difficult.

During peak hours also disc jockeys (DJ) may be found at service's. Generally DJs play that music style which the service provider has ordered or his/her own selection. DJs also take wishes from customers. Some DJs have a certain style according to which the service providers can decide which one to order. DJs have a great expertise where the music selection is based on.

A music transfer via network has developed to a popular way for private listeners to listen and download music. A man skilled in the art will appreciate the numerous method and techniques to transfer music e.g. via internet. Music files are transferred from a remote server for to be played in client personal computers. Music services offer different ways for music selection. A subscriber can choose from one to many music pieces to be played or compose an own play list of singles or choose a complete play list, chosen by the music service provider. However these music services, as said, are mainly utilized by private persons. The features of the current music services are not the ones the service provider in restaurants or other public services would require. Reason is clear-internet based music services not necessarily offer trusted partner for the service provider and the work for selecting the music pieces can consume too much time.

What is needed then, is a system, which can be used for providing media content, such as music to public services, and which does not require too much (or at all) contribution from the service provider. In addition the system should still provide music content dynamically, in real-time and still provide such the content, which fulfils the needs of the service provider.

### SUMMARY OF THE INVENTION

It is thus an aim of the current invention to automatize the selecting process for media content and provide an intelligent database search targeted to an extensive data library.

Another aim of the current invention is to extract wanted content from the database and provide it dynamically to the service provider.

Yet another aim of the current invention is to provide such media content, which suites the style of the service provider, which suites the atmosphere as well as the time of the day.

More precisely, the system according to the invention is mainly characterized in that the request for music transfer is a constant request and the content provider is configured to select the content being transferred dynamically. The method according to the invention is mainly characterized in that, a constant request is received whereby the content being transferred is selected dynamically. The computer program product is mainly characterized in that the request is a constant request, whereupon the program comprises instructions for selecting the content being transferred dynamically.

Other features of the invention is presented in the appended dependent claims.

The invention provides considerable advantages comparing to systems of related art. Due to the invention e.g. music content can be easily selected in real time. The service provider is offered a possibility to reduce own responsibility for the music selection but still receive music which has been selected with good taste and which matches the wishes of the service provider. The desired media content is selected based on a static order request from the service provider. The selection is, however, made dynamically, whereby the transfer itself, however, comprises dynamically varying pieces.

By means of the system it is possible to direct the desired content to the receiver, whereby it mainly rises to the present challenges, not so much to the data transfer (even though the data transfer is a significant factor in the system), because the system enables the selection of desired media content or style from one database (library) to several clients. In addition the system reacts to the need of present music technology that is to achieve legal basis to the music transfer and reliable and real time monitor for copyrights. By means of the system it is possible to report the playing times and clients in detailed manner, and therefore direct the royalties straight to the authors.

The invention provides a solution to the challenges of a data management, for it enables an automatic extraction of the desired data from the extensive database.

### DESCRIPTION OF THE DRAWINGS

A better understanding of the invention may be obtained from the following considerations taken in conjunction with the accompanying drawings, which are not meant to restrict the scope of the invention in any way. Further objects and advantages of the invention are also considered in the following description. The invention itself is defined with particularity in the claims.

FIG. 1 illustrates one example of possible configuration of the system according to the invention, and

FIG. 2 illustrates another example of the system according to the invention.

### DETAILED DESCRIPTION OF THE INVENTION

The invention relates to a decentralized interactive virtual DJ system that is supplied with artificial intelligence. By means of the system digital media content (e.g. music) can be sent and received. In the system the sending and receiving process is automatic, thanks to the artificial intelligence. The automatic sending and receiving means that because the media content files being stored in the database comprises needed amount of metadata, the receiving device is capable of receiving only the desired media content and other information, without having a user for carrying out the actions at the time of the event. The system is therefore utilizing the features of a semantic network. Although specific terms are used in the following description for the sake of clarity, these terms are intended to refer only to the particular structure of the invention selected for illustration in the drawings and are not intended to define or limit the scope of the invention. In the description term “content provider” corresponds to the one managing the media library and offering the media content transfer according to the invention. The content provider transfers media content to the “public service”, which in this example is a restaurant, a public house, a bar etc. It should be noticed that the public service can be almost any service which needs this kind of content provision. In addition to the public service also private persons, consumers can utilize the media content transfer as a radio or e.g. as a DJ in a party. “Media content” refers to media types generally, but the description uses music as an example.

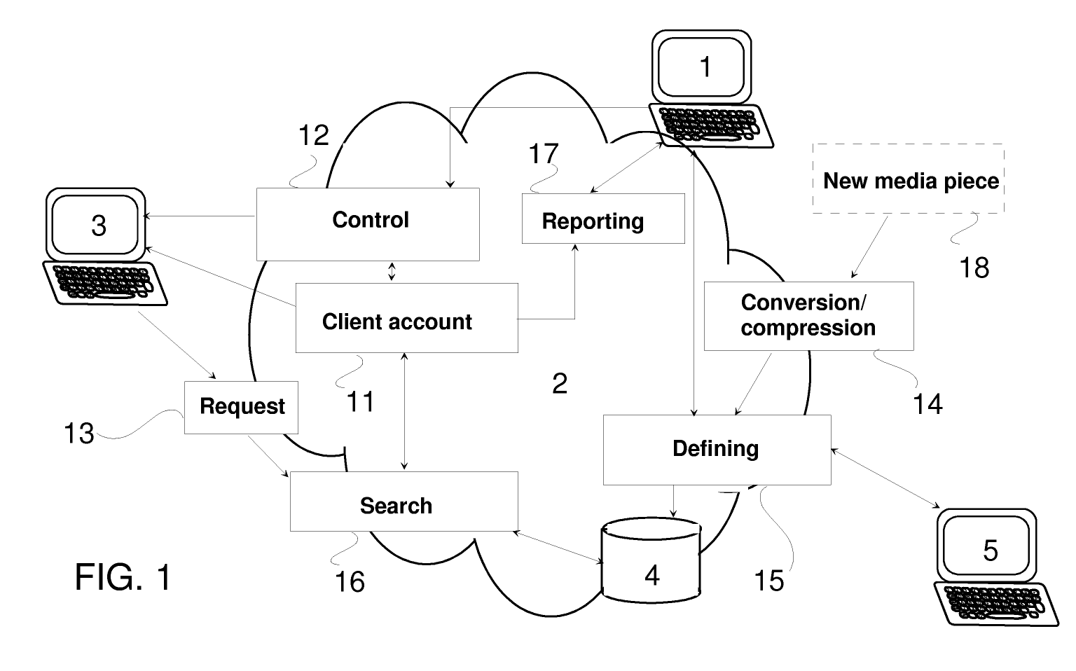

FIG. 1 illustrates one possible configuration for the system. The system according to the invention comprises a database 4 for storing digital media content and a server 2, through which the media content is reachable. In this description the system is simulating DJ actions. For this, the database 4 is stored with audio files (video and text files are possible as well) for which such a metadata that professional DJs are utilizing in their work is attached. The metadata comprises at least a name of the performer as well as name of the piece can be defined, but also one or many of the other parameters such as genre, year, origin, internationality, hit rate, quality, tempo, party rate, sing-along etc. are defined. Naturally there are also other data which can be configured to the music pieces, such as a screenshot or a music video. The database 4 can be e.g. a MySQL/SQL-database. New media pieces are added to the database 4, but before that they are converted from records, such as CDs and vinyls, into digital form and further compressed them into music data files (14). The audio compression can be done for example by Ogg Vorbis method, but also by other known methods such as MP3, Real Audio, WMA (Windows Media Audio), AAC (Advanced Audio Coding), etc. The music pieces are characterized (15) by different parameters. The system may comprise virtual DJ characters at the receiving end, which DJ characters are created with a user interface of their own kind and which can be specified according the needs/requirements of the client (e.g. restaurant etc.). In addition there is a search engine for media files, by means of which it is possible to select any file from the library to be e.g. a request or a jukebox like action.

When defining the metadata for the music pieces the professional help is preferably utilized. For example one or more DJs 5 can have an access to the database 4 for characterizing the pieces. Every time a new song or record is added to the media library in the database 4, the DJ 5 is asked to characterize it. It will be evident, that almost any method can be used for characterizing music. In this example the system according to the invention comprises a web-based user interface for the DJ by means of which the classification can be implemented via network. Of course the DJ can always come to content provider's and define the songs afterwards or during the conversion.

A client device 3, such as a personal computer or other computing device, is connected to the system. The client device 3 most probably locates physically separate from the database 4 e.g. at the premises of the public service or other utilizing the system according to the invention. The connection can be made by any known communication network. The communication network can be a wired communication network (e.g. LAN) or wireless long or short radio frequency network (e.g. GPRS, UMTS, EDGE, WCDMA, CDMA; WLAN, HiperLan/2, . . . ). For example, transmission rate of 256 bit/s can be required.

The service provider uses the client device 3 for accessing e.g. internet and further the content provider. A user interface is presented for the client, which interface is arranged into the client device 3 and which can be used for requesting certain media content. The user interface can be a web based site or a tailored software, and it enables easier selection of the content being transferred. The service provider is advantageously already a subscriber to the content provision, but obviously the relation to the content provider 1 can be created along the request 13. Typically more than one client can be connected to the content provider 1.

The client's account 11 for the content is preferably tailored for every client and it is easy to update and use. The client 3 can request a specific media content by defining few parameters for the content or by choosing a virtual DJ. Parameters can relate to mood or time of the day. Based on those parameters the system provides the music dynamically from the database 4. It should be noticed, that the client does not need (though it is possible) to select single pieces, and due to this the provided content usually varies. For example if the client desires 80's hits at lunch time, the transferred content may comprise more energetic songs than if the client has ordered the 80's content at late night. Similarly, when e.g. a jazz-night is ordered, the content dynamically varies along the night. In other words, according to the invention, the request 13 coming from the client defines the area, whereupon the system is configure to search and select the single songs. This means, that if the client chooses a similar area (such as jazz) time after time, transferred songs however may be different at each time. Similarly, by choosing the virtual DJ, the music pieces correspond its style. The virtual DJ can be presented e.g. at service's screen, where it can jam along the music. The virtual DJ may also be configured to host and give needed announcements and information as well as greeting (e.g. SMS messages) along the music playing via a speech synthesizer and animation.

When a request 13 is made, the music pieces are searched from the database 4. When a piece is found, it is used for composing a play list, which list is then stored to client's account 11 and streamed to client's device 3. The play list is composed dynamically to the client account 11, which means that the play list does not necessarily need to be complete when the streaming is began. The streaming to the client can be started when there is only one or couple of songs ready. The customers are also given a possibility to wish the music. In this situation the content provider can be configured to inform how well that piece will match the chosen style. Because the client account 11 is augmented dynamically, the customer's wishes are possible to insert to it in very short time period.

The content provider is also configured to observe and control 12 the client account 11, whether there are enough playable music pieces and to add music pieces to the client account 11 according to the request 13 of the client. These functions can be implemented as software programs. In this description the functions are implemented as two programs, but the man skilled in the art will appreciate, that also one program taking care of them both is possible. The add function generates dynamically a play list of music pieces to be transferred to the client and it utilizes the parameters and the style of the client for generating the content. The add function is also configured to memorize the recently played and not to put them again in the same session. The control function observers the client account 11, and if there are not enough songs, it is configured to call the add function.

The system according to the invention is further configured to make reports 17 of the played music. The reports 17 specifies the clients and the content they have ordered. The reports can be viewed by the content provider 1 and printed out and used for invoicing and e.g. for reporting to the copyright society. If needed, also service provider can have access to reports.

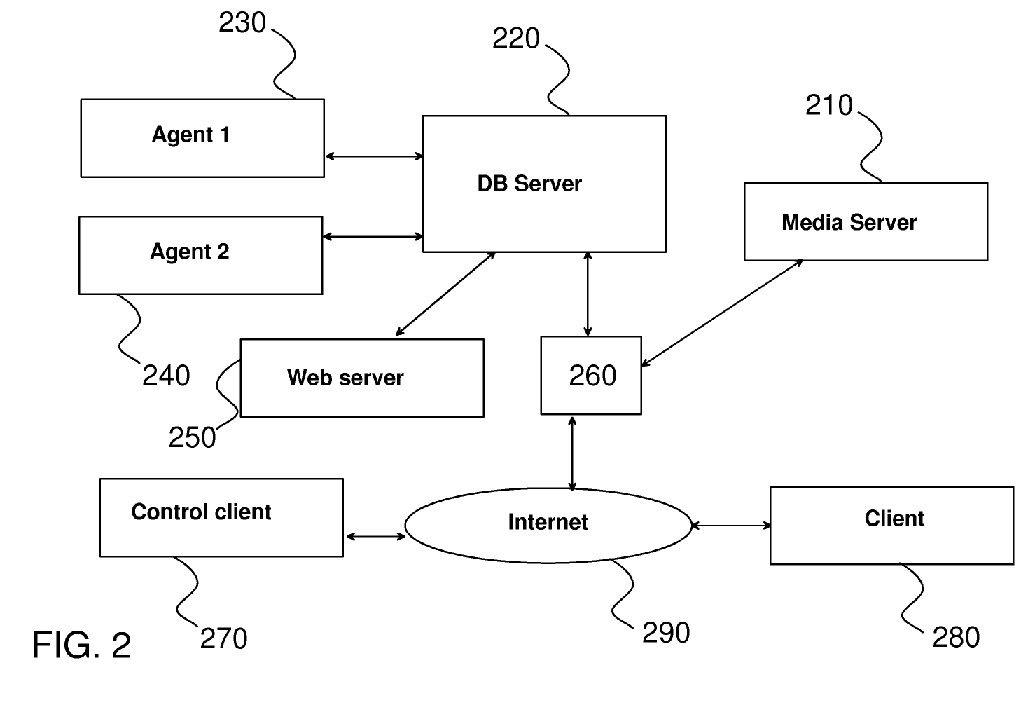

Another example of the system according to the invention is illustrated in a very simplified manner in FIG. 2. It can be seen, that system comprises a media server 210, which provides the needed media content, e.g. audio files, to a client 230. The media transfer is in this example carried out by means of the Internet. The system comprises also a database server 220 that comprises the information about the client, information about media content and parameters relating to them. The database comprises also the playback parameters of all the DJs and a possible playing time. Client devices are configured to report for played media content into the database. In this example two agents 230, 240 are arranged to the system, but in some situations agents can be more or less. Agent 1 (230) is configured to observe the possible exchanges of DJs and also the fact that the client has enough playable media content and informs agent 2 (240) about possible changes. If needed the agent 2 (240) adds media content according to parameters of the DJ in question. However, the agent 2 (240) keeps in mind, which media content is already played for the current client and what are wished or wanted to be played. According these checks the transferred media content is chosen.

The web sever 250 of the system is controlling e.g. the SQL-connections and the communication with the client devices. The web server 250 comprises also web based client user interfaces. In the FIG. 2 also fire wall and bandwidth limiter (260) are illustrated. The control client device (270) is used for adding media content and for giving parameters for said media content according to specific rules. The client device (280) receives interactively the media content according to the wishes of the client via Internet 290.

The system can be controlled by a mobile terminal if desired, whereby the requests can be presented and paid by means of said terminal. DJ online is possible to be utilized e.g. as a background music in television night programs (e.g. chat programs), wherein it is also possible to make requests via a mobile terminal or e.g. vote the DJ for the night. In addition an automatic radio that is controllable by the users (listeners) with the mobile terminal is possible to arranged with the system.

Music library or database is possible to broaden to music videos or other media content. Therefore it is possible to send audio and video at the same time, whereby the DJ acts as a video jockey. By combining the speech synthesizer and animation with the simultaneous sending of audio and video, it is possible to configure a karaoke system wherein the DJ character may act as a karaoke host and present the next song and the singer for that like a real host. The database can be build from audio books and hence create a system where audio books are classified and from which it is possible to download a book to be listened to home terminal and listen it the desired time.

As said earlier the system can be based on computing. The interfaces can be implemented as web sites using some markup language, such as HTML, XML, WML etc. whereupon the system will operate as web site and will be browsable by browsers. The programming language in the server can be e.g. PHP (Hypertext Preprocessing), MySQL (Structured Query Language), or other server programming languages.

The man skilled in the art will appreciate the possible applications of the invention. For example the database can be reached also from other computing device such as a mobile terminal. The receiver of the system can be also e.g. a PDA device or similar. The service can be directed also to consumers in addition to restaurants. Consumers may order DJ on demand in the form of application rent for desired time. In addition, the client can ask only for single pieces in stead of the area. And further, the media content can comprise also other media than music, such as video (music videos) or text (karaoke service).

Additionally the aforementioned systems and databases are example embodiments; one skilled in the art will appreciate that numerous other databases and systems may suitably communicate with the present system in order to provide enhanced functionality.

It is thus understood that the foregoing detailed description is provided for clearness of understanding only. It should then be understood that the invention itself is targeted for providing client specific streaming media content by selecting a dynamic content due to a constant request. Thus not necessarily limitation should be read therefrom into the claims herein.

1. A system for transferring media content via network, said system comprising a content provider (1, 210) and at least one client device (3, 280) and a network connection (290) configured between them, said system comprising also a database (4, 220) for storing said media content, wherein said content provider (1, 280) is configured to receive a request (13) from at least one client device (3, 280), said request (13) identifying the content client desires, characterized in that, said request (13) is a constant request and the content provider (1, 210) is configured to select the content being transferred dynamically.

2. The system according to claim 1, characterized in that, the content provider (1, 210) is configured to notice other features than the request (13) and select the content according to them.

3. The system according to claim 2, characterized in that, the other features relate to a situation, where the media content is being transferred.

4. The system according to one of the preceding claims 1-3, characterized by a client account (11) for each client for storing the selected content.

5. The system according to claim 4, characterized by means (12, 230) for controlling the client account (11).

6. The system according to claim 4 or 5, characterized by means for inserting (240) new media pieces to the client account.

7. The system according to one of the preceding claims 1-6, characterized by means for defining (15) characteristics of the media content.

8. The system according to one of the preceding claims 1-7, characterized in that, the constant request is a request for a music style, wherein the dynamically selected content comprises single music pieces.

9. The system according to one of the preceding claims 1-8, characterized in that, the constant request is a request for virtual DJ.

10. The system according to one of the preceding claims 1-9, characterized in that, the client device comprises a user interface, which is provided by the content provider (1).

11. A method for transferring media content via network from a content provider (1) to at least one client device (3), wherein a request (13) is received by the content provider (1) from at least one client device (3), said request (13) identifying the content the client desires, characterized in that, a constant request (13) is received after which the content being transferred is selected dynamically.

12. The method according to claim 11, characterized in that, other features than the request (13) are noticed, whereby the content is selected according also to them.

13. The method according to claim 11 or 12, characterized in that other features are defined, which other features relate to a situation, where the media content is being transferred.

14. The method according to one of the preceding claims 11-13, characterized in that, the selected content is stored in a client account (11) dynamically.

15. The method according to one of the preceding claims 11-14, characterized in that, the selected content comprises media pieces that are dynamically stored in the client account (11).

16. The method according to claim 15, characterized in that, the client account is controlled by checking the amount of media pieces and recently transferred media pieces.

17. The method according to claim 16, characterized in that new media pieces are added to the client account.

18. The method according to one of the preceding claims 11-17, characterized in that, the media content is characterized by different features and stored in a database (4).

19. The method according to one of the preceding claims 11-18, characterized in that, at least one virtual DJ is provided for selecting music content.

20. A computer program product for transferring media content via network, said computer program product comprising memory means for storing a computer readable program comprising instructions for receiving a request from a client device, said request identifying the content the client desires, characterized in that, said request is a constant request, whereupon the program comprises instructions for selecting dynamically the content being transferred.

21. The computer program product according to claim 20, characterized in that, the instructions are configured to notice other features than the request and select the content according to them.
